(19) United States
(12) Patent Application Publication
(10) Pub. No.: US 2026/0052171 A1
(43) Pub. Date: Feb. 19, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Jun KANAI, Inagi Tokyo (JP); Tatsuya UEHARA, Kawasaki Kanagawa (JP); Ryuiti KOIKE, Kawasaki Kanagawa (JP); Hayeong SHIN, Ota Tokyo (KR)

(73) Assignee: KABUSHIKI KAISHA TOSHIBA, Tokyo (JP)

(21) Appl. No.: 19/265,437

(22) Filed: Jul. 10, 2025

(30) Foreign Application Priority Data
Aug. 13, 2024 (JP) 2024-134755

(51) Int. Cl. H04L 9/40

(52) U.S. Cl. CPC H04L 63/1441; H04L 63/1416

(57) ABSTRACT

In an information processing apparatus according to an embodiment, a processor acquires a load state of each resource in an information processing system, and determines whether one of the resources is subjected to a high-load attack. In response to affirmative determination, the processor identifies an attack target service subjected to the high-load attack from among services executed in the information processing system, based on the attack target resource subjected to the high-load attack among the resources. The processor determines a priority of the attack target service based on priority information in which priority indicating a level at which each service is preferentially processed is described. The processor determines, based on the priority of the attack target service, a target restriction content indicating a content to restrict execution of one of the services. The processor restricts the execution of the one of the services according to the target restriction content.

### CROSS-REFERENCE TO RELATED APPLICATIONS

This application is based upon and claims the benefit of priority from Japanese Patent Application No. 2024-134755, filed on Aug. 13, 2024; the entire contents of which are incorporated herein by reference.

### FIELD

Embodiments described herein relate generally to an information processing apparatus, an information processing method, and a computer program product.

### BACKGROUND

In recent years, distributed processing techniques using a large number of physical computers or virtual computers have been widely used with the spread of clouds.

For example, there is also known a cloud that automatically allocates a resource to a computer to enhance the computing capability of the computer when the computing capability of the computer is insufficient with respect to the processing amount of a service.

However, such a cloud allocates a large amount of resources to a service subjected to a distributed denial of service (DDoS) attack when receiving a cyberattack called the DDoS attack that causes a large amount of resources to be consumed and makes the service inexecutable. Therefore, when such a cloud is subjected to the DDoS attack, an operation cost is greatly increased.

Considering the above, an information processing system such as a cloud is required to have a technology capable of appropriately allocating a resource even in a case of receiving a cyberattack that increases a processing load of the resource such as the DDoS attack.

### BRIEF DESCRIPTION OF THE DRAWINGS

FIG. 1 is a diagram illustrating an information processing system and an attack monitoring apparatus;

FIG. 2 is a diagram illustrating a configuration of an attack monitoring apparatus;

FIG. 3 is a diagram illustrating attack determination rule information;

FIG. 4 is a diagram illustrating priority information;

FIG. 5 is a diagram illustrating restriction rule information;

FIG. 6 is a diagram illustrating release rule information;

FIG. 7 is a flowchart illustrating a procedure of restriction processing;

FIG. 8 is a flowchart illustrating a procedure of release processing; and

FIG. 9 is a diagram illustrating an example of a hardware configuration of the attack monitoring apparatus.

### DETAILED DESCRIPTION

An information processing apparatus according to one embodiment includes a hardware processor connected to a memory. The hardware processor is configured to acquire a load state of each of resources included in an information processing system, and determine whether or not one of the resources is subjected to a high-load attack, based on the load state of each of the resources. The hardware processor is configured to, in response to determining that one of the resources is subjected to the high-load attack, identify an attack target service subjected to the high-load attack from among services executed in the information processing system. The attack target service is identified based on the attack target resource subjected to the high-load attack among the resources. The hardware processor is configured to determine a priority of the attack target service based on priority information in which priority indicating a level at which each of the services is preferentially processed is described. The hardware processor is configured to determine, based on the priority of the attack target service, a target restriction content indicating a content to restrict execution of one of the services in the information processing system. The hardware processor is configured to restrict the execution of the one of the services by the information processing system according to the target restriction content.

Hereinafter, embodiments of the present invention will be described with reference to the accompanying drawings.

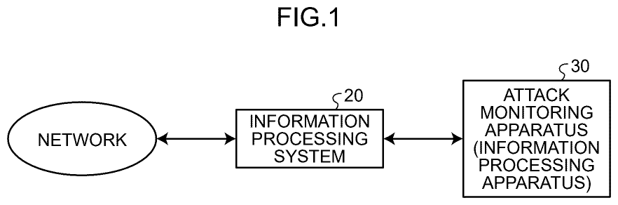

FIG. 1 is a diagram illustrating an information processing system 20 and an attack monitoring apparatus 30 according to an embodiment.

The information processing system 20 is a computing system that executes information processing. The information processing system 20 may be a single physical computer made of hardware, or may be a system in which a plurality of physical computers provided at different locations operates in cooperation via a network. The information processing system 20 may be a cloud that provides information processing to a computer terminal device outside the information processing system 20 via a network.

The information processing system 20 includes multiple computers each executing information processing according to a computer program. The computers may execute different information processing or may execute one piece of information in a distributed manner. Each of the computers may be a physical computer or a virtual computer. The virtual computer is a computer virtually implemented on one or more physical computers, virtually including a configuration similar to that of the physical computer, and executes information processing similarly to the physical computer. Similarly to the physical computer, the virtual computer is connected to an external computer terminal device via a network.

Each of the computers includes a plurality of resources. Each of the resources is, for example, a processor, a memory, a storage, a network interface, or the like. Note that the processor, the memory, the storage, the network interface, or the like may have a virtual configuration. The processor is, for example, a central processing unit (CPU). The memory stores data that is accessed by the processor and processed by the processor. The storage is accessed by the processor and stores a file including data to be processed by the processor. The storage can continue to store files even when the processor is not operating. The network interface is connected to a computer terminal device outside the information processing system 20 via a network. Each of the computers acquires a request from the computer terminal device or transmits a processing result according to the request via the network interface. Note that each of the computers may include other types of resources other than the processor, the memory, the storage, and the network interface.

The information processing system 20 executes plural services by each of the computers executing a program. The services receive a request and execute information processing according to the received request.

In addition, each of the services is provided by executing one or more processes in the physical computer or the virtual computer. Each of the one or more processes is a program in a state of being executed in the physical computer or the virtual computer. In addition, the physical computer or the virtual computer may execute a process in units called containers. In addition, the physical computer or the virtual computer may execute the program in units called PODs that store a plurality of containers. The plurality of containers included in one POD share the same storage and the same network interface.

Such an information processing system 20 automatically allocates resources to services so as to appropriately process each of the services being executed. For example, the information processing system 20 allocates a relatively large number of computers, processors, memories, and storages to a service having a relatively large processing amount per unit time using, for example, a virtualization technology. As a result, the information processing system 20 can appropriately execute a service having a relatively large processing amount per unit time without delay. On the other hand, for example, the information processing system 20 allocates a relatively small number of computers, processors, memories, and storages to a service having a relatively small processing amount per unit time using, for example, a virtualization technology. As a result, the information processing system 20 can appropriately execute a service having a relatively small processing amount per unit time at a low cost.

The attack monitoring apparatus 30 is an example of an information processing apparatus that controls execution of services by the information processing system 20. The attack monitoring apparatus 30 is implemented by an information processing apparatus such as a computer. The attack monitoring apparatus 30 monitors whether or not the information processing system 20 is subjected to a cyberattack via a network. Specifically, the attack monitoring apparatus 30 monitors whether or not, for example, a DDoS attack or the like is received as the cyberattack. The DDoS attack is a high-load attack that gives a large number of requests to the information processing system 20 to bring a resource included in the computer into a high-load state. When receiving the high-load attack, the attack monitoring apparatus 30 appropriately allocates a resource to each of one or more computers included in the information processing system 20 according to the priority set to each of the services.

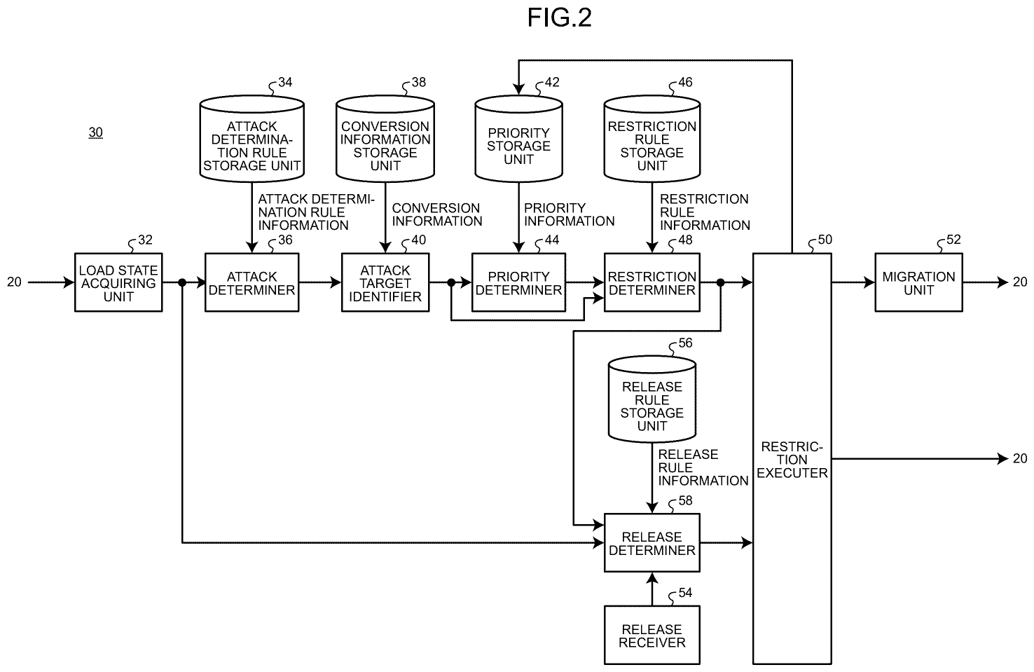

FIG. 2 is a diagram illustrating a configuration of the attack monitoring apparatus 30 according to the embodiment.

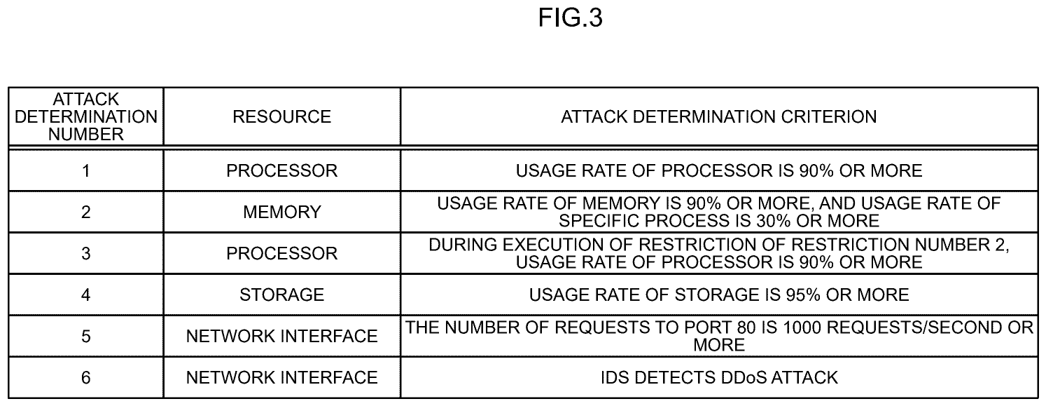

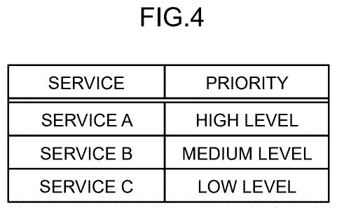

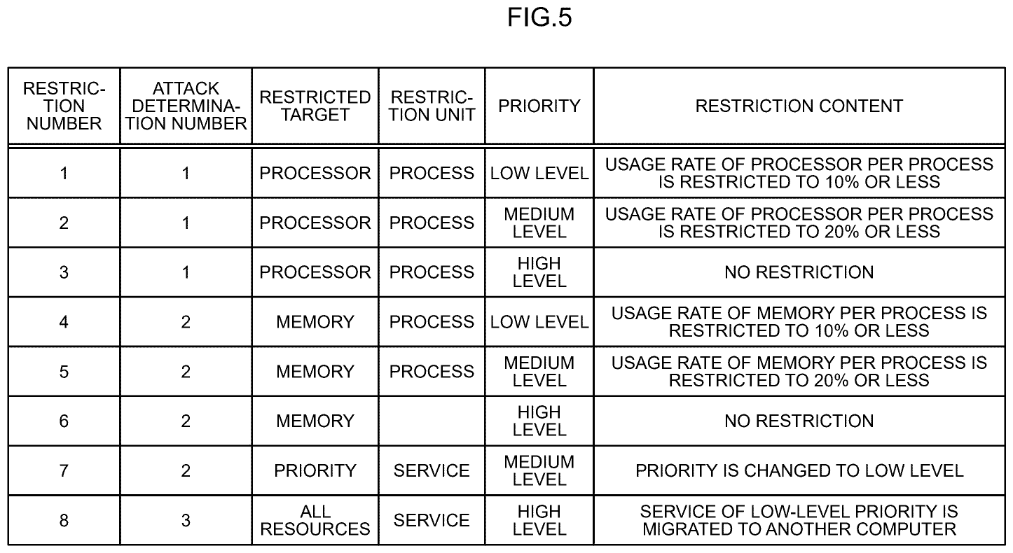

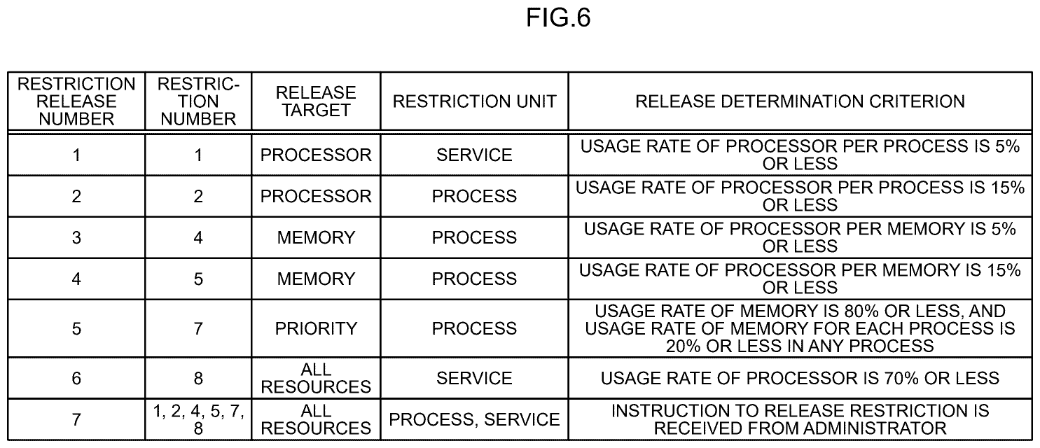

Note that, in describing the attack monitoring apparatus 30 with reference to FIG. 2, FIGS. 3, 4, 5, and 6 will be referred to. FIG. 3 is a diagram illustrating an example of attack determination rule information. FIG. 4 is a diagram illustrating an example of priority information. FIG. 5 is a diagram illustrating an example of restriction rule information. FIG. 6 is a diagram illustrating an example of release rule information.

The attack monitoring apparatus 30 includes a load state acquiring unit 32, an attack determination rule storage unit 34, an attack determiner 36, a conversion information storage unit 38, an attack target identifier 40, a priority storage unit 42, a priority determiner 44, a restriction rule storage unit 46, a restriction determiner 48, a restriction executer 50, a migration unit 52, a release receiver 54, a release rule storage unit 56, and a release determiner 58.

The load state acquiring unit 32 acquires the load state of each of the resources included in the information processing system 20. Each of the resources is a processor, a memory, a network interface, a storage, or the like. Note that each of the resources may have a virtual configuration such as a virtual processor and a virtual memory.

For example, the load state acquiring unit 32 acquires a relative usage amount for at least some resources of the resources as a load state. For example, the load state acquiring unit 32 acquires a usage rate of the processor, a usage rate of the memory, the number of requests to a predetermined port (for example, port 80) of the network per unit time, a storage usage rate, and the like as a relative usage amount.

In addition, the load state acquiring unit 32 may acquire the absolute usage amount of the resource as the load state. For example, the load state acquiring unit 32 may acquire the operation time of the processor, the usage amount of the memory, the number of requests to a predetermined port (for example, port 80) of the network, and the usage amount of the storage as the absolute usage amount of the resource.

In addition, the load state acquiring unit 32 may use a computer as a resource and acquire information provided by an operation system of the computer as the load state. For example, the load state acquiring unit 32 may acquire the number of files and the number of file handle descriptors as the load state of the computer.

In addition, the load state acquiring unit 32 may acquire the relative usage amount of the resource or the absolute use amount of the resource for each process as the load information. For example, the load state acquiring unit 32 may acquire a usage rate or an operation time of the processor for each process, a usage rate or a usage amount of the memory for each process, the number of requests or the number of requests per unit time for each process to a predetermined port (for example, port 80) of the network, a usage rate or a usage amount of the storage for each process, and the like.

In a case where the information processing system 20 monitors a traffic of the network by, for example, an intrusion detection system (IDS) or the like and detects that a high-load attack such as a DDoS attack or the like is received, the load state acquiring unit 32 may acquire whether or not the high-load attack is received as the load state of the network.

The load state acquiring unit 32 acquires the load state of each of the resources for each of the computers included in the information processing system 20. Then, the load state acquiring unit 32 gives the load state of each of the resources included in the information processing system 20 to the attack determiner 36 and the release determiner 58.

The attack determination rule storage unit 34 stores preset attack determination rule information. In the attack determination rule information, at least one attack determination criterion is described for determining whether any one of the resources is subjected to the high-load attack. Each of the at least one attack determination criterion represents that a high-load attack is being received when the load state of one of the resources is greater than or equal to a predetermined threshold value or less.

The attack determination rule information is, for example, information as illustrated in FIG. 3. For example, the attack determination rule information in FIG. 3 indicates six attack determination criteria. A unique attack determination number is set for each of the six attack determination criteria. In addition, each of the six attack determination criteria is correlated with a resource that is an attack determination target.

The attack determination criterion of the attack determination number “1” in FIG. 3 indicates that the attack determination target resource is a processor, and indicates determination that a high-load attack has been performed when the usage rate of the processor is 90% or more. The attack determination criterion of the attack determination number “2” in FIG. 3 indicates that the attack determination target resource is a memory, and indicates determination that a high-load attack has been performed when the usage rate of the memory is 90% or more and the usage rate of a specific process is 30% or more. The attack determination criterion of the attack determination number “3” in FIG. 3 indicates that the attack determination target resource is a processor, and indicates determination that a high-load attack has been performed when the usage rate of the processor is 90% or more while the restriction of the restriction number “2” is being executed. Note that the restriction of the restriction number “2” is determined by the restriction determiner 48 and is an example of the restriction of the execution of the service by the restriction executer 50.

The attack determination criterion of the attack determination number “4” in FIG. 3 indicates that the attack determination target resource is a storage, and indicates determination that a high-load attack has been performed when the usage rate of the storage is 95% or more. The attack determination criterion of the attack determination number “5” in FIG. 3 indicates that the attack determination target resource is a network interface, and indicates determination that a high-load attack has been performed when the number of requests to the port 80 of the network per second is 1000 or more. The attack determination criterion of the attack determination number “6” in FIG. 3 indicates that the attack determination target resource is a network interface, and indicates determination that a high-load attack has been performed when the IDS detects a DDos attack.

Such attack determination rule information is created in advance by, for example, an administrator or the like of the attack monitoring apparatus 30 and stored in the attack determination rule storage unit 34. In addition, the information processing system 20 applied to the social infrastructure often has a fixed behavior. Therefore, the attack determination rule information may be created by machine learning or the like by a learning device. In addition, the learning device may generate the attack determination rule information by applying the idea of anomaly detection. For example, when applying the concept of anomaly detection, the learning device acquires the usage rate of the processor during a normal operation of the information processing system 20. Then, in a case where the usage rate of the processor during the normal operation is not 70% or more, for example, and in a case where the usage rate of the processor is 80% or more obtained by adding a margin to 70%, the learning device generates an attack determination criterion for determining that a high-load attack has been made.

The attack determiner 36 acquires the load state of each of the resources included in the information processing system 20 from the load state acquiring unit 32. Then, the attack determiner 36 determines whether or not any one of the resources provided in the information processing system 20 is subjected to the high-load attack based on the load state of each of the resources and the attack determination rule information stored in the attack determination rule storage unit 34. For example, for each of at least one attack determination criterion described in the attack determination rule information, the attack determiner 36 determines whether or not a high-load attack is received by comparing a load state of a corresponding resource among the resources with a threshold described in the attack determination criterion.

For example, in a case where the attack determination rule information is set as in the example illustrated in FIG. 3, the attack determiner 36 acquires the usage rate of the processor as the load state for the attack determination criterion of the attack determination number “1”. Then, the attack determiner 36 determines that the processor is under the high-load attack in a case where the acquired usage rate of the processor is 90% or more which is the threshold value.

In a case where the attack determination rule information is set as in the example illustrated in FIG. 3, the attack determiner 36 acquires the usage rate of the memory and the usage rate of the memory for each process as the load state for the attack determination criterion of the attack determination number “2”. Then, the attack determiner 36 determines that the memory is under the high-load attack in a case where the acquired usage rate of the memory is 90% or more, which is the threshold value, and the usage rate of the memory of the specific process is 30% or more, which is the threshold value.

In a case where the attack determination rule information is set as in the example illustrated in FIG. 3, the attack determiner 36 acquires, as the load state, the usage rate of the processor acquired during the execution of the restriction of the restriction number “2” with respect to the attack determination criterion of the attack determination number “3”. Then, the attack determiner 36 determines that the processor is under the high-load attack in a case where the acquired usage rate of the processor during the execution of the restriction of the restriction number “2” is 80% or more which is the threshold value.

In a case where the attack determination rule information is set as in the example illustrated in FIG. 3, the attack determiner 36 acquires the usage rate of the storage as the load state for the attack determination criterion of the attack determination number “4”. Then, the attack determiner 36 determines that the storage thereof is under the high-load attack in a case where the acquired usage rate of the processor is 95% or more which is the threshold value.

In a case where the attack determination rule information is set as in the example illustrated in FIG. 3, the attack determiner 36 acquires the number of requests per second to the port 80 of the network as the load state for the attack determination criterion of the attack determination number “5”. Then, the attack determiner 36 determines that the network is under the high-load attack in a case where the acquired number of requests to the port 80 of the network per second is 1000 or more which is the threshold value.

In a case where the attack determination rule information is set as in the example illustrated in FIG. 3, the attack determiner 36 acquires a value indicating whether or not a DDos attack on the network has been detected as the load state for the attack determination criterion of the attack determination number “6”. Then, the attack determiner 36 determines that the network is under the high-load attack in a case where the acquired value coincides with a value indicating that the DDos attack, which is a threshold value, has been detected.

Such an attack determiner 36 gives a determination result as to whether or not the high-load attack is received to the attack target identifier 40. In addition, in response to determining that the attack target resource is subjected to the high-load attack, the attack determiner 36 gives information for identifying the attack target resource determined to be subjected to the high-load attack and an attack determination number for identifying an attack determination criterion that is a basis of the determination that the attack target resource is subjected to the high-load attack to the attack target identifier 40 and the restriction determiner 48.

The conversion information storage unit 38 stores conversion information that correlates a process, a container, a POD, a physical computer, or a logical computer executed in the information processing system 20, with a service executed in the information processing system 20. The conversion information may be, for example, expression information for linking a process and a service for each application program. In addition, the conversion information may be a manifest file in which components, libraries, and the like referred to in the program are described for each application program.

In response to determining that any one of the resources is subjected to the high-load attack, the attack target identifier 40 identifies the attack target service subjected to the high-load attack among the services executed in the information processing system 20 based on the attack target resource subjected to the high-load attack among the resources. For example, the attack target identifier 40 identifies a process, a container, a POD, or a computer using the attack target resource based on the attack target resource. Then, the attack target identifier 40 identifies the attack target service based on the process, the container, the POD, or the computer executed in the attack target resource.

For example, when calculating the usage rate of the resource, the load state acquiring unit 32 normally calculates the usage rate of the resource in units of processes. Therefore, the attack target identifier 40 can identify the process using the attack target resource by referring to the information acquired by the load state acquiring unit 32. The attack target identifier 40 can also identify a container in which the process operates and a POD that stores the container from the process.

Then, the attack target identifier 40 identifies the attack target service from the process, the container, the POD, the physical computer, or the logical computer using the attack target resource with reference to the conversion information stored in the conversion information storage unit 38. For example, the attack target identifier 40 identifies the attack target service based on the expression information linking the process and the service for each application program and the identified process. In addition, the attack target identifier 40 identifies a container in which the process operates from the identified process, and identifies the attack target service based on the manifest file and the identified container.

The priority storage unit 42 stores priority information. In the priority information, priority representing a level at which each of services executed in the information processing system 20 is preferentially processed is described. For example, in the example of FIG. 4, the priority information represents the priority of “high level”, “medium level”, or “low level”. A service set to “high level” is a service to be processed in preference to services set to “medium level” and “low level”. A service set to “medium level” is a service to be processed in preference to a service set to “low level” and to be executed without preference to a service set to “high level”. A service set to “low level” is a service to be executed without preference to services set to “medium level” and “high level”. In the example of FIG. 4, the priority is represented by three levels, but may be two levels or four or more levels. The priority information is created in advance by an administrator or the like of the attack monitoring apparatus 30 and stored in the priority storage unit 42.

The priority determiner 44 acquires information for identifying the attack target service from the attack target identifier 40. The priority determiner 44 determines the priority of the attack target service based on the information for identifying the attack target service and the priority information stored in the priority storage unit 42. For example, as in the example of FIG. 4, in a case where the priority indicates “high level”, “medium level”, or “low level”, the priority determiner 44 determines the priority of the attack target service to be any of “high level”, “medium level”, or “low level” set corresponding to the attack target service by the priority information. The priority determiner 44 gives the determined priority of the attack target service to the restriction determiner 48.

The restriction rule storage unit 46 stores the restriction rule information. The restriction contents are described in the restriction rule information. Each of the restriction contents indicates a content of restriction on execution of a service out of the services. For example, each of the restriction contents corresponds to any one attack determination criterion of at least one attack determination criterion and the level of the priority. Each of the restriction contents is a restriction for changing the load state of the resource determined to be subjected to the high-load attack in a direction in which the resource is not determined to be subjected to the high-load attack, and represents a restriction of strength according to the level of the corresponding the priority.

For example, the restriction rule information is information as illustrated in FIG. 5. For example, the restriction rule information in FIG. 5 indicates eight restriction contents. For each of the eight restriction contents, a unique restriction number is set. Each of the eight restriction contents is correlated with an attack determination number, a restriction target, the unit of restriction, and a priority for identifying an attack determination criterion that is the basis for the determination that a high-load attack is received.

In a case of the restriction content of the restriction number “1” in FIG. 5, the attack determination number is “1”, the restriction target corresponds to the processor, the unit of restriction corresponds to the process, and the priority corresponds to the low level. The restriction content of the restriction number “1” is “to restrict the usage rate of the processor per process to 10% or less”.

In a case of the restriction content of the restriction number “2” in FIG. 5, the attack determination number is “1”, the restriction target corresponds to the processor, the unit of restriction corresponds to the process, and the priority corresponds to the medium level. The restriction content of the restriction number “2” is “to restrict the usage rate of the processor per process to 20% or less”.

In a case of the restriction content of the restriction number “3” in FIG. 5, the attack determination number is “1”, the restriction target corresponds to the processor, the unit of restriction corresponds to the process, and the priority corresponds to the high level. The restriction content of the restriction number “3” is “no restriction”.

In a case of the restriction content of the restriction number “4” in FIG. 5, the attack determination number is “2”, the restriction target corresponds to the memory, the unit of restriction corresponds to the process, and the priority corresponds to the low level. The restriction content of the restriction number “4” is “to restrict the usage rate of the memory per process to 10% or less”.

In a case of the restriction content of the restriction number “5” in FIG. 5, the attack determination number is “2”, the restriction target corresponds to the memory, the unit of restriction corresponds to the process, and the priority corresponds to the medium level. The restriction content of the restriction number “5” is “to restrict the usage rate of the memory per process to 20% or less”.

In a case of the restriction content of the restriction number “6” in FIG. 5, the attack determination number is “2”, the restriction target corresponds to the memory, the unit of restriction corresponds to the process, and the priority corresponds to the high level. The restriction content of the restriction number “6” is “no restriction”.

In a case of the restriction content of the restriction number “7” in FIG. 5, the attack determination number is “2”, the restriction target corresponds to the priority, the unit of restriction corresponds to the service, and the priority corresponds to the medium level. The restriction content of the restriction number “7” is “change the priority level to the low level”.

In a case of the restriction content of the restriction number “8” in FIG. 5, the attack determination number is “3”, the restriction target corresponds to all resources, the unit of restriction corresponds to the service, and the priority corresponds to the high level. The restriction content of the restriction number “8” is “migrate the low-level priority service to another computer”.

In one example, the priority indicates at least a first level or a second level. The second level is a level that is not processed in preference to the first level.

In such a case, a first restriction content that is one of the restriction contents may indicate that, in a case where the first restriction content corresponds to the first attack determination criterion of the at least one attack determination criterion and the priority of the attack target service corresponds to the first level, a first operation restriction that restricts the execution of a service out of the services is executed. Then, a second restriction content that is one of the restriction contents may indicate that in a case where the second restriction content corresponds to the first attack determination criterion and the priority of the attack target service corresponds to the second level, a second operation restriction that restricts the execution of a service out of the services is executed. In this case, the first operation restriction is a restriction that changes the load state of the resource determined to be subjected to the high-load attack more strongly in a direction not determined to be subjected to the high-load attack than the second operation restriction.

For example, in the example of FIG. 5, in a case where the first restriction content is the restriction content of the restriction number “2”, the second restriction content is the restriction content of the restriction number “1”. In the example of FIG. 5, in a case where the first restriction content is the restriction content of the restriction number “5”, the second restriction content is the restriction content of the restriction number “4”.

By performing restriction with the first restriction content and the second restriction content, when receiving a high-load attack such as a DDoS attack, the attack monitoring apparatus 30 can suppress the operation cost of the information processing system 20 by reducing the resource allocated to the service with low priority, and can increase the probability that the service with high priority will be continuously executed.

Moreover, a third restriction content which is one of the restriction contents may indicate that, in a case where the priority of the attack target service corresponds to the first level, the priority of the attack target service is changed from the first level to the second level. For example, in the example of FIG. 5, the third restriction content is the restriction content of the restriction number “7”.

By performing restriction with the third restriction content, in a case where determination is made such that the attack target resource is subjected to the high-load attack even if the first operation restriction is executed, the attack monitoring apparatus 30 can further suppress the operation cost of the information processing system 20 by performing stronger restriction and reducing the resource to be allocated to the attack target service.

In addition, a fourth restriction content that is one of the restriction contents may indicate that in a case where the fourth restriction content corresponds to the first attack determination criterion of the at least one attack determination criterion and the priority of the attack target service corresponds to the first level, the execution of the attack target service is not restricted. Then, a fifth restriction content that is one of the restriction contents may indicate that in a case where the fifth restriction content corresponds to the first attack determination criterion and the priority of the attack target service corresponds to the second level, execution of the attack target service is restricted.

For example, in the example of FIG. 5, in a case where the fourth restriction content is the restriction content of the restriction number “3”, the fifth restriction content is the restriction content of the restriction number “1” or “2”. In addition, in the example of FIG. 5, in a case where the fourth restriction content is the restriction content of the restriction number “6”, the fifth restriction content is the restriction content of the restriction number “4” or “5”.

By performing restriction with the fourth restriction content and the fifth restriction content, when receiving a high-load attack such as a DDoS attack, the attack monitoring apparatus 30 can suppress the operation cost of the information processing system 20 by reducing the resource allocated to the service with low priority, and can more increase the probability that the service with high priority will be continuously executed.

In addition, a sixth restriction content that is one of the restriction contents may indicate that in a case where the sixth restriction content corresponds to the first attack determination criterion of the at least one attack determination criterion and the priority of the attack target service corresponds to the first level, the execution of the service of which the priority is the second level among the services is restricted without restricting the execution of the attack target service. For example, in the example of FIG. 5, the sixth restriction content is the restriction content of the restriction number “8”.

By performing restriction with the sixth restriction content, when receiving a high-load attack such as a DDoS attack, the attack monitoring apparatus 30 can relatively increase the resources for the service with high priority by reducing the resource allocated to the service with low priority, and can further increase the probability that the service with high priority will be continuously executed.

In addition, it is assumed that the attack target service is executed by a first computer out of the multiple computers. In this case, a seventh restriction content which is one of the restriction contents may indicate that in a case where the priority of the attack target service corresponds to the first level, migration is performed to cause a second computer different from the first computer out of the multiple computers to execute a service of which the priority executed by the first computer is the second level. For example, in the example of FIG. 5, the seventh restriction content is the restriction content of the restriction number “8”.

By performing restriction with the seventh restriction content, when receiving a high-load attack such as a DDoS attack, the attack monitoring apparatus 30 can increase the availability of resources of the first computer by migrating a service with a low priority executed by the first computer, and can further increase the probability that an attack target service with a high priority will be continuously executed.

Based on the priority of the attack target service, the restriction determiner 48 determines a target restriction content indicating a content to restrict execution of a service out of the services in the information processing system 20. More specifically, the restriction determiner 48 determines the target restriction content based on the target attack determination criterion that is the basis for the determination that a high-load attack is received in at least one attack determination criterion described in the attack determination criterion information, the priority of the attack target service determined by the priority determiner 44, and the restriction rule information stored in the restriction rule storage unit 46.

The restriction determiner 48 acquires, from the attack determiner 36, information (for example, the attack determination number) for identifying a target attack determination criterion from which it has been determined that a high-load attack is received in at least one attack determination criterion described in the attack determination criterion information. The restriction determiner 48 further acquires the priority of the attack target service from a priority determiner 33. Then, the restriction determiner 48 determines, as the target restriction content, the restriction content corresponding to the target attack determination criterion and the level of the priority of the attack target service among the restriction contents described in the restriction rule information.

In a case where the restriction rule information is set as in the example illustrated in FIG. 5, the target attack determination criterion of the attack determination number “1” is acquired, and the priority of the attack target service is “low level”, the restriction determiner 48 determines the restriction content of the restriction number “1” that restricts the usage rate of the processor per process in the attack target service to 10% or less as the target restriction content.

In a case where the restriction rule information is set as in the example illustrated in FIG. 5, the target attack determination criterion of the attack determination number “1” is acquired, and the priority of the attack target service is “medium level”, the restriction determiner 48 determines the restriction content of the restriction number “2” that restricts the usage rate of the processor per process in the attack target service to 20% or less as the target restriction content.

In a case where the restriction rule information is set as in the example illustrated in FIG. 5, the target attack determination criterion of the attack determination number “1” is acquired, and the priority of the attack target service is “high level”, the restriction determiner 48 determines the restriction number “3” restriction content for which no restriction is set as the target restriction content.

In a case where the restriction rule information is set as in the example illustrated in FIG. 5, the target attack determination criterion of the attack determination number “2” is acquired, and the priority of the attack target service is “low level”, the restriction determiner 48 determines the restriction content of the restriction number “4” that restricts the usage rate of the memory per process in the attack target service to 10% or less as the target restriction content.

In a case where the restriction rule information is set as in the example illustrated in FIG. 5, the target attack determination criterion of the attack determination number “2” is acquired, and the priority of the attack target service is “medium level”, the restriction determiner 48 determines the restriction content of the restriction number “5” that restricts the usage rate of the memory per process in the attack target service to 20% or less as the target restriction content.

In a case where the restriction rule information is set as in the example illustrated in FIG. 5, the target attack determination criterion of the attack determination number “2” is acquired, and the priority of the attack target service is “high level”, the restriction determiner 48 determines the restriction number “6” restriction content for which no restriction is set as the target restriction content.

In a case where the restriction rule information is set as in the example illustrated in FIG. 5, the target attack determination criterion of the attack determination number “2” is acquired, and the priority of the attack target service is “medium level”, the restriction determiner 48 determines the restriction content of the restriction number “7” that changes the priority corresponding to the attack target service in the priority information stored in the priority storage unit 42 to a low level as the target restriction content.

In addition, in a case where the restriction rule information is set as in the example illustrated in FIG. 5, the target attack determination criterion of the attack determination number “3” is acquired, and the priority of the attack target service is “medium level”, the restriction determiner 48 determines the restriction content of the restriction number “8” in which the service having the low priority executed in the same computer as the attack target service is migrated to another computer as the target restriction content.

The restriction determiner 48 provides information (for example, the restriction number) for identifying the target restriction content determined in this manner to the restriction executer 50 and the release determiner 58.

The restriction executer 50 acquires information (for example, the restriction number) for identifying the target restriction content determined by the restriction determiner 48. In a case where the restriction determiner 48 determines execution of the restriction, the restriction executer 50 restricts the execution of the service by the information processing system 20 according to the target restriction content. For example, in a case of restricting the usage rate of the processor per process, the restriction executer 50 gives an instruction to the information processing system 20 to restrict the usage rate of the target processor per process. Moreover, for example, in a case of restricting the usage rate of the memory per process, the restriction executer 50 gives an instruction to the information processing system 20 to restrict the usage rate of the target memory per process.

In addition, for example, when the restriction content for changing the priority of the service is determined, the restriction executer 50 rewrites the priority of the corresponding service included in the priority information stored in the priority storage unit 42. In addition, for example, when the restriction content for migrating the service to another computer is determined, the restriction executer 50 gives an instruction to the migration unit 52 and causes the migration unit 52 to execute the migration.

In addition, in a case where the release of the restriction executed by the release determiner 58 is determined, the restriction executer 50 stops the restriction for which the release is determined and returns the restriction to the state before the release.

The migration unit 52 performs migration of causing a second computer that is different from the first computer among the multiple computers to execute a service that has been executed by the first computer in accordance with an instruction from the restriction executer 50. In this manner, when the migration unit 52 receives an instruction of migration from the restriction executer 50, the migration unit changes the computer by which the instructed service is to be executed.

In addition, the migration unit 52 may change the computer to be the migration destination according to the priority of the service to be migrated. For example, when the service having the second level of the priority is migrated, the migration unit 52 may migrate to a computer having a smaller margin of calculation capability than when the service having the first level of the priority is migrated. The first level represents a level to be processed in preference to the second level. As a result, the migration unit 52 can further increase the probability that the attack target service with high priority will be continuously executed.

When restricting the execution of the service, the release receiver 54 receives an instruction to release the restriction from the administrator.

The release rule storage unit 56 stores preset release rule information. At least one release determination criterion for releasing the restriction on the execution of the service is described in the release rule information. Each of the at least one release determination criterion indicates that the restriction on the execution of the service is released when the load state of one of the resources is greater than or equal to a predetermined threshold value or less. In addition, at least one release determination criterion may indicate that the restriction on the execution of the service according to the target restriction content is released when the release receiver 54 receives an instruction to release the restriction from the administrator regarding the target restriction content.

For example, the release rule information is information as illustrated in FIG. 6. For example, the release rule information in FIG. 6 indicates seven release determination criteria. A unique release determination number is set for each of the seven release determination criteria. Each of the seven release determination criteria is correlated with a restriction number identifying a corresponding restriction content out of the restriction contents, a release target, and the unit of restriction.

In a case of the release determination criterion of the release determination number “1” in FIG. 6, the restriction content of the restriction number corresponds to “1”, the release target corresponds to the processor, and the unit of restriction corresponds to the process. The release determination criterion of the release determination number “1” in FIG. 6 indicates that the restriction of the restriction number “1” is released when the usage rate of the processor per process becomes 5% or less during the execution of the restriction of the restriction content of the restriction number “1”.

In a case of the release determination criterion of the release determination number “2” in FIG. 6, the restriction content of the restriction number corresponds to “2”, the release target corresponds to the processor, and the unit of restriction corresponds to the process. The release determination criterion of the release determination number “2” in FIG. 6 indicates that the restriction of the restriction number “2” is released when the usage rate of the processor per process becomes 15% or less during the execution of the restriction of the restriction content of the restriction number “2”.

In a case of the release determination criterion of the release determination number “3” in FIG. 6, the restriction content of the restriction number corresponds to “4”, the release target corresponds to the memory, and the unit of restriction corresponds to the process. Then, the release determination criterion of the release determination number “3” in FIG. 6 indicates that the restriction of the restriction number “4” is released in a case where the usage rate of the memory per process becomes 5% or less during the execution of the restriction of the restriction content of the restriction number “4”.

In a case of the release determination criterion of the release determination number “4” in FIG. 6, the restriction content of the restriction number corresponds to “5”, the release target corresponds to the memory, and the unit of restriction corresponds to the process. Then, the release determination criterion of the release determination number “4” in FIG. 6 indicates that the restriction of the restriction number “5” is released in a case where the usage rate of the memory per process becomes 15% or less during the execution of the restriction of the restriction content of the restriction number “5”.

In a case of the release determination criterion of the release determination number “5” in FIG. 6, the restriction content of the restriction number corresponds to “7”, the release target corresponds to the priority, and the unit of restriction corresponds to the service. Then, the release determination criterion of the release determination number “5” in FIG. 6 indicates that the restriction of the restriction number “7” is released in a case where the usage rate of the memory is 80% or less and the usage rate of the memory for each process is 20% or less in a process during the execution of the restriction of the restriction content of the restriction number “7”.

In a case of the release determination criterion of the release determination number “6” in FIG. 6, the restriction content of the restriction number corresponds to “8”, the release target corresponds to all resources, and the unit of restriction corresponds to the service. The release determination criterion of the release determination number “6” in FIG. 6 indicates that the restriction of the restriction number “8” is released when the usage rate of the processor becomes 70% or less during the execution of the restriction of the restriction content of the restriction number “8”.

In a case of the release determination criterion of the release determination number “7” in FIG. 6, the restriction content of the restriction numbers corresponds to “1, 2, 4, 5, 7, and 8”, the release target corresponds to all resources, and the unit of restriction corresponds to the process and the service. The release determination criterion of the release determination numbers “1, 2, 4, 5, 7, and 8” in FIG. 6 indicates that the restriction of the restriction numbers “1, 2, 4, 5, 7, and 8” is released when the release receiver 54 receives an instruction to release the restriction from the administrator.

Note that the threshold value of the release determination criterion may be a value in which the load state of the resource is lower than the threshold value in the restriction content of the corresponding restriction number. As a result, the attack monitoring apparatus 30 can eliminate an operation of frequently repeating the start of the service restriction and the release of the service restriction, such as immediately starting the service restriction after releasing the restriction on the service.

The release determiner 58 acquires the load state of each of the resources included in the information processing system 20 from the load state acquiring unit 32. In addition, the release determiner 58 acquires information (for example, the restriction number) for identifying the target restriction content determined by the restriction determiner 48.

Then, the release determiner 58 determines whether or not to release the restriction on the execution of the service according to the target restriction content based on the load state of each of the resources, the target restriction content, and the release rule information stored in the release rule storage unit 56. For example, the release determiner 58 determines to release the restriction on the execution of the service according to the target restriction content by comparing the threshold indicated in the release determination criterion corresponding to the target restriction content among at least one release determination criterion described in the release rule information with the load state of the corresponding resource among the resources. In addition, for example, when one of at least one release determination criterion describes that the restriction is released when an instruction to release the restriction is received from the administrator, and an instruction to release the restriction is received from the administrator, the release determiner 58 determines to release the restriction on the execution of the service according to the target restriction content.

In a case where the release determination rule information is set as in the example illustrated in FIG. 6, during the execution of the restriction of the restriction number “1”, the release determiner 58 determines to release the restriction of the restriction number “1” when the usage rate of the processor per process is 5% or less.

In a case where the release determination rule information is set as in the example illustrated in FIG. 6, during the execution of the restriction of the restriction number “2”, the release determiner 58 determines to release the restriction of the restriction number “2” when the usage rate of the processor per process is 15% or less.

In a case where the release determination rule information is set as in the example illustrated in FIG. 6, during the execution of the restriction of the restriction number “4”, the release determiner 58 determines to release the restriction of the restriction number “4” when the usage rate of the memory per process is 5% or less.

In a case where the release determination rule information is set as in the example illustrated in FIG. 6, during the execution of the restriction of the restriction number “5”, the release determiner 58 determines to release the restriction of the restriction number “5” when the usage rate of the memory per process is 15% or less.

In a case where the release determination rule information is set as in the example illustrated in FIG. 6, during the execution of the restriction of the restriction number “7”, the release determiner 58 determines to release the restriction of the restriction number “7” when the usage rate of the memory is 80% or less and the usage rate of each process is 20% or less in any process.

In a case where the release determination rule information is set as in the example illustrated in FIG. 6, during the execution of the restriction of the restriction numbers “1, 2, 4, 5, 7, and 8”, the release determiner 58 determines to release the restriction of the restriction numbers “1, 2, 4, 5, 7, and 8” when the release receiver 54 receives an instruction to release the restriction from the administrator.

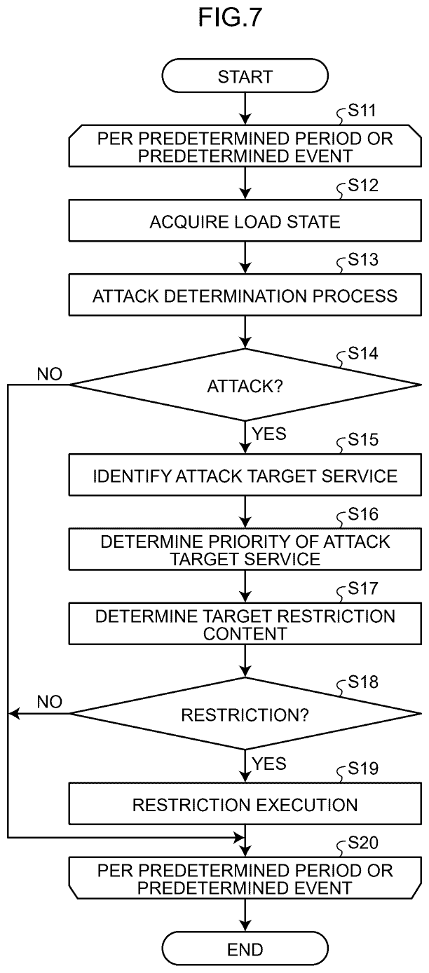

FIG. 7 is a flowchart illustrating a procedure of restriction processing in the attack monitoring apparatus 30 according to the embodiment. The attack monitoring apparatus 30 executes the restriction processing in the flow illustrated in FIG. 7.

The attack monitoring apparatus 30 executes the processing from S12 to S19 for each predetermined period or each predetermined event (loop processing between S11 and S20).

In S12, the attack monitoring apparatus 30 acquires the load state of each of the resources included in the information processing system 20.

Subsequently, in S13, the attack monitoring apparatus 30 determines whether or not at least one of the resources provided in the information processing system 20 is subjected to the high-load attack based on the load state of each of the resources and the attack determination rule information. For example, for each of at least one attack determination criterion described in the attack determination rule information, the attack monitoring apparatus 30 determines whether or not a high-load attack is received by comparing a load state of a corresponding resource out of the resources with a threshold described in the attack determination criterion.

In S14, the attack monitoring apparatus 30 determines whether a high-load attack has been received based on the determination result. In response to determining that the high-load attack has not been received (No in S14), the attack monitoring apparatus 30 exits the loop processing, waits for the process until a predetermined time elapses or until the next event, and repeats the process from S12 after the predetermined period elapses or after the next event occurs. When it is the determination result that the high-load attack is received (Yes in S14), the attack monitoring apparatus 30 proceeds the process to S15.

In S15, the attack monitoring apparatus 30 identifies the attack target service subjected to the high-load attack among the services executed in the information processing system 20 based on the attack target resource subjected to the high-load attack among the resources. For example, the attack target identifier 40 identifies a process, a container, a POD, or a computer using the attack target resource based on the attack target resource. Then, the attack target identifier 40 identifies the attack target service based on the process, the container, the POD, or the computer executed in the attack target resource.

Subsequently, in S16, the attack monitoring apparatus 30 determines the priority of the attack target service based on the information for identifying the attack target service and the priority information.

In S17, the attack monitoring apparatus 30 determines the target restriction content based on the target attack determination criterion that is the basis for determination that a high-load attack is received in at least one attack determination criterion described in the attack determination criterion information, the priority of the attack target service determined by the priority determiner 44, and the restriction rule information.

Subsequently, in S18, the attack monitoring apparatus 30 determines whether or not to actually execute the restriction based on the determined target restriction content. For example, in a case where the priority of the attack target service is at a high level, the attack monitoring apparatus 30 determines not to execute the restriction. In response to determining that the restriction is not executed (No in S18), the attack monitoring apparatus 30 exits the loop processing, waits for the process until a predetermined time elapses or until the next event, and repeats the process from S12 after the predetermined period elapses or after the next event occurs. In response to determining that the restriction is executed (Yes in S18), the attack monitoring apparatus 30 proceeds the process to S19.

In S19, the attack monitoring apparatus 30 restricts the execution of the attack target service according to the determined target restriction content. Then, when S19 ends, the attack monitoring apparatus 30 exits the loop processing, waits for the process until a predetermined time elapses or until the next event, and repeats the process from S12 after the predetermined period elapses or after the next event occurs (loop processing between S11 and S20).

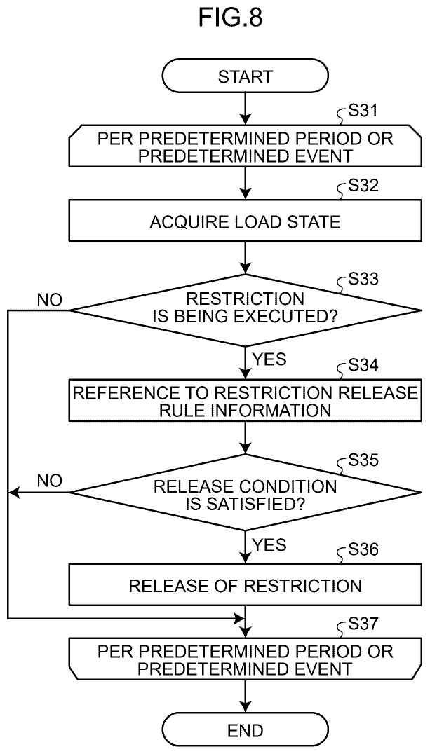

FIG. 8 is a flowchart illustrating a procedure of release processing in the attack monitoring apparatus 30 according to the embodiment. The attack monitoring apparatus 30 executes the release processing in the flow illustrated in FIG. 8.

The attack monitoring apparatus 30 executes the processing from S32 to S19 for each predetermined period or each predetermined event (loop processing between S31 and S37).

In S32, the attack monitoring apparatus 30 acquires the load state of each of the resources included in the information processing system 20.

Subsequently, in S33, the attack monitoring apparatus 30 determines whether or not the restriction is being executed. In response to determining that the restriction is not being executed (No in S33), the attack monitoring apparatus 30 exits the loop processing, waits for the process until a predetermined time elapses or until the next event, and repeats the process from S32 after the predetermined period elapses or after the next event occurs. When the restriction is being executed (Yes in S33), the attack monitoring apparatus 30 proceeds the process to S34.

In S34, the attack monitoring apparatus 30 refers to the restriction release rule information.

In S35, the attack monitoring apparatus 30 determines whether the restriction content to be restricted satisfies the release condition indicated by the restriction release rule information. In a case where the release condition is not satisfied (No in S35), the attack monitoring apparatus 30 exits the loop processing, waits for the process until a predetermined time elapses or until the next event, and repeats the process from S32 after the predetermined period elapses or after the next event occurs. When the release condition is satisfied (Yes in S35), the attack monitoring apparatus 30 proceeds the process to S36.

In S36, the attack monitoring apparatus 30 releases the executed restriction. Then, when S36 ends, the attack monitoring apparatus 30 exits the loop processing, waits for the process until a predetermined time elapses or until the next event, and repeats the process from S32 after the predetermined period elapses or after the next event occurs (loop processing between S11 and S20).

As described above, when receiving a high-load attack such as a DDoS attack that increases the processing load of resources, the attack monitoring apparatus 30 according to the present embodiment changes the resources to be allocated to the service under attack in response to the priority of the service under attack. For example, when receiving a high-load attack, the attack monitoring apparatus 30 allocates more resources to a service with a high priority than to a service with a low priority. As a result, the attack monitoring apparatus 30 can suppress the operation cost by increasing the probability that the service with high priority is continuously executed and restricting the resource for the service with low priority. As described above, the attack monitoring apparatus 30 can appropriately allocate the resource to each of the services even when receiving a high-load attack such as a DDoS attack that increases the processing load of the resource.

Hardware configuration of information processing apparatus

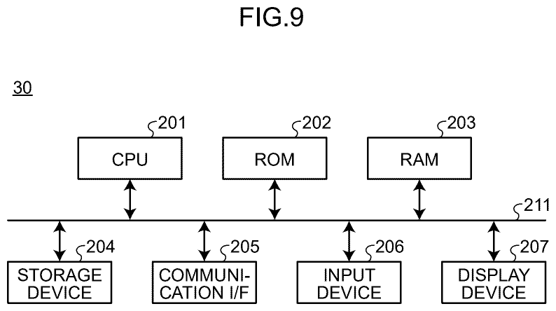

FIG. 9 is a diagram illustrating an example of a hardware configuration of the attack monitoring apparatus 30.

The attack monitoring apparatus 30 is implemented by, for example, an information processing apparatus having a hardware configuration as illustrated in FIG. 9. The attack monitoring apparatus 30 includes a CPU 201, a read only memory (ROM) 202, a random access memory (RAM) 203, a storage device 204, a communication I/F 205, an input device 206, and a display device 207. These units are connected to each other via a bus 211.

The CPU 201 is a processor that executes arithmetic processing, control processing, and the like in accordance with a computer program. The CPU 201 uses a predetermined area of the RAM 203 as a work area, and executes various types of processing in cooperation with programs stored in the ROM 202, the storage device 204, and the like.

The ROM 202 is a memory that stores programs and various types of information in a non-rewritable manner. The RAM 203 is a memory such as a synchronous dynamic random access memory (SDRAM). The RAM 203 functions as a work area of the CPU 201.

The storage device 204 is a device that writes and reads data in and from a semiconductor storage medium such as a flash memory, a magnetically or optically recordable storage medium, or the like. The storage device 204 writes and reads data to and from the storage medium under the control of the CPU 201. The communication device I/F 205 communicates with an external device via a network in accordance with control from the CPU 201.

The input device 206 is an input device such as a mouse and a keyboard. The input device 206 receives information operationally input from the administrator as an instruction signal, and outputs an instruction signal to the CPU 201.

The display device 207 is a display device such as a liquid crystal display (LCD). The display device 207 displays various types of information based on a display signal from the CPU 201.

The program executed by the information processing apparatus includes a load state acquiring module, an attack determining module, an attack target identifying module, a priority determining module, a restrict determining module, a restrict executing module, a migration module, a release receiving module, and a release determining module.

This program is developed and executed on the RAM 203 by the CPU 201 (processor), thereby causing the information processing apparatus to function as the load state acquiring unit 32, the attack determiner 36, the attack target identifier 40, the priority determiner 44, the restriction determiner 48, the restriction executer 50, the migration unit 52, the release receiver 54, and the release determiner 58. Note that a part or all of each of the load state acquiring unit 32, the attack determiner 36, the attack target identifier 40, the priority determiner 44, the restriction determiner 48, the restriction executer 50, the migration unit 52, the release receiver 54, and the release determiner 58 may be implemented by a hardware circuit. In addition, this program causes the RAM 203 or the storage device 204 to function as the attack determination rule storage unit 34, the conversion information storage unit 38, the priority storage unit 42, the restriction rule storage unit 46, and the release rule storage unit 56.

In addition, the program executed by the information processing apparatus can be provided by being recorded in an information processing apparatus-readable recording medium such as a CD-ROM, a flexible disk, a CD-R, or a digital versatile disk (DVD) as a file in a format that can be installed or executed in the information processing apparatus. Such a recording medium may be provided as a computer program product.

The computer program may be stored on an information processing apparatus connected to a network such as the Internet and provided by being downloaded via the network. The program may be provided or distributed via a network such as the Internet. The program executed by the attack monitoring apparatus 30 may be provided by being incorporated in the ROM 202 or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
a hardware processor connected to a memory, the hardware processor being configured to:
acquire a load state of each of resources included in an information processing system;
determine whether or not one of the resources is subjected to a high-load attack, based on the load state of each of the resources;
in response to determining that one of the resources is subjected to the high-load attack, identify an attack target service subjected to the high-load attack from among services executed in the information processing system, the attack target service being identified based on the attack target resource subjected to the high-load attack among the resources;
determine a priority of the attack target service based on priority information in which priority indicating a level at which each of the services is preferentially processed is described;
determine, based on the priority of the attack target service, a target restriction content indicating a content to restrict execution of one of the services in the information processing system; and
restrict the execution of the one of the services by the information processing system according to the target restriction content.

2. The information processing apparatus according to claim 1, wherein
the information processing system includes multiple computers each configured to execute one of the services, and
the hardware processor is configured to, when restricting the execution of the one of the services executed by a first computer, perform migration of causing a second computer different from the first computer among the multiple computers to execute the one of the services.

3. The information processing apparatus according to claim 1, wherein the hardware processor is configured to
determine whether to release the restriction on the execution of the one of the services according to the target restriction content, based on the load state of each of the resources, the target restriction content, and at least one piece of release rule information in which a release determination criterion for releasing the restriction on the execution of the service is described, and,
in response to determining to release the restriction on the execution of the one of the services according to the target restriction content, release the restriction on the execution of the one of the services according to the target restriction content.

4. The information processing apparatus according to claim 1, wherein the hardware processor is configured to
identify, based on the attack target resource, a process, a container, a POD, or a computer, each using the attack target resource, and
identify the attack target service based on the process, the container, the POD, or the computer executed on the attack target resource.

5. The information processing apparatus according to claim 1, wherein
the hardware processor is configured to perform the determination about whether or not one of the resources is subjected to the high-load attack, based on the load state of each of the resources and the attack determination rule information,
the attack determination rule information includes at least one attack determination criterion,
each of the at least one attack determination criterion indicates that determination that the high-load attack is received is made when the load state is greater than or equal to a predetermined threshold value or less for one of the resources, and
the hardware processor is configured to perform the determination about whether or not the high-load attack is received, by comparing the load state of a corresponding resource among the resources with the threshold value for each of the at least one attack determination criterion.

6. The information processing apparatus according to claim 5, wherein
the hardware processor is configured to determine the target restriction content based on
a target attack determination criterion being a source of determination that the attack target service is subjected to the high-load attack among the at least one attack determination criterion,
the priority of the attack target service, and
restriction rule information,
the restriction rule information describes restriction contents each representing a content of restriction on execution of one of the services,
each of the restriction contents represents a restriction that corresponds to one of the attack determination criteria of the at least one attack determination criterion and a level of the priority and changes the load state of the resource determined to be subjected to the high-load attack in a direction not determined to be subjected to the high-load attack, and represents a restriction of strength according to a level of the corresponding priority, and
the hardware processor is configured to determine, as the target restriction content, a restriction content corresponding to the target attack determination criterion and the level of the priority of the attack target service among the restriction contents.

7. The information processing apparatus according to claim 6, wherein
the priority indicates at least a first level or a second level that is not preferentially processed as compared with the first level,
the restriction contents includes a first restriction content representing that, when the first restriction content corresponds to a first attack determination criterion of the at least one attack determination criterion and the priority of the attack target service corresponds to the first level, a first operation restriction of restricting execution of one of the services is executed,
the restriction contents includes a second restriction content representing that, when the second restriction content corresponds to the first attack determination criterion and the priority of the attack target service is the second level, a second operation restriction for restricting execution of one of the services is executed, and
the first operation restriction represents that changes the load state of the resource determined to be subjected to the high-load attack more strongly in a direction not determined to be subjected to the high-load attack than the second operation restriction.

8. The information processing apparatus according to claim 7, wherein the restriction contents includes a third restriction content representing that, when the priority of the attack target service corresponds to the first level, the priority of the attack target service is changed from the first level to the second level.

9. The information processing apparatus according to claim 6, wherein
the priority indicates at least a first level or a second level that is not preferentially processed as compared with the first level,
the restriction contents includes a fourth restriction content representing that, when the fourth restriction content corresponds to the first attack determination criterion of the at least one attack determination criterion and the priority of the attack target service corresponds to the first level, the execution of the attack target service is not restricted, and
the restriction contents includes a fifth restriction content representing that, when the fifth restriction content corresponds to the first attack determination criterion and the priority of the attack target service corresponds to the second level, the execution of the attack target service is restricted.

10. The information processing apparatus according to claim 6, wherein
the priority indicates at least a first level or a second level that is not preferentially processed as compared with the first level, and
the restriction contents includes a sixth restriction content representing that, when the sixth restriction content corresponds to the first attack determination criterion of the at least one attack determination criterion and the priority of the attack target service corresponds to the first level, the execution of the service of which the priority is the second level among the services is restricted without restricting the execution of the attack target service.

11. The information processing apparatus according to claim 10, wherein
the information processing system includes multiple computers each configured to execute one of the services,
the attack target service is executed by a first computer out of the multiple computers, and
the restriction contents includes a seventh restriction content representing that, when the priority of the attack target service corresponds to the first level, migration is performed to cause a second computer different from the first computer among the multiple computers to execute a service of which the priority executed by the first computer is the second level.

12. The information processing apparatus according to claim 3, wherein
each of the at least one release determination criterion indicates that the restriction on the execution of the service is released when the load state of one of the resources is greater than or equal to a predetermined threshold value or less, and
the hardware processor is configured to determine to release the restriction on the execution of the service by comparing the load state of a corresponding resource among the resources with the threshold value for each of the at least one of the release determination criteria.

13. The information processing apparatus according to claim 12, wherein one of the at least one release determination criterion indicates that the restriction on the execution of the service according to the target restriction content is released when an instruction to release the restriction is received from the administrator regarding the target restriction content.

14. The information processing apparatus according to claim 2, wherein
the priority indicates at least a first level or a second level that is not preferentially processed as compared with the first level, and
the hardware processor is configured to, when the service having the second level of the priority is migrated, migrate to a computer having a smaller margin of calculation capability than when the service having the first level of the priority is migrated.

15. An information processing method implemented by an information processing apparatus, the information processing apparatus serving to control execution of a service by an information processing system, the method comprising:
acquiring a load state of each of resources included in the information processing system;
determining whether or not one of the resources is subjected to a high-load attack, based on the load state of each of the resources;
in response to determining that one of the resources is subjected to the high-load attack, identifying an attack target service subjected to the high-load attack from among services executed in the information processing system, the attack target service being identified based on the attack target resource subjected to the high-load attack among the resources;
determining a priority of the attack target service based on priority information in which priority indicating a level at which each of the services is preferentially processed is described;
determining, based on the priority of the attack target service, a target restriction content indicating a content to restrict execution of one of the services in the information processing system; and
restricting the execution of the one of the services by the information processing system according to the target restriction content.

16. A computer program product comprising a non-transitory computer readable recording medium on which a computer program executable by a computer is recorded, the computer program instructing the computer to perform processing, the processing including:
acquiring a load state of each of resources included in an information processing system;
determining whether or not one of the resources is subjected to a high-load attack, based on the load state of each of the resources;
in response to determining that one of the resources is subjected to the high-load attack, identifying an attack target service subjected to the high-load attack from among services executed in the information processing system, the attack target service being identified based on the attack target resource subjected to the high-load attack among the resources;
determining a priority of the attack target service based on priority information in which priority indicating a level at which each of the services is preferentially processed is described;
determining, based on the priority of the attack target service, a target restriction content indicating a content to restrict execution of one of the services in the information processing system; and
restricting the execution of the one of the services by the information processing system according to the target restriction content.
